(19) United States
(12) Patent Application Publication
(10) Pub. No.: US 2015/0023657 A1
(43) Pub. Date: Jan. 22, 2015

(54) Instant photography with ordinary shell film

(71) Applicant: Robert J. Crowley, Sudbury, MA (US)

(72) Inventor: Robert J. Crowley, Sudbury, MA (US)

(21) Appl. No.: 13/987,361

(22) Filed: Jul. 16, 2013

(51) Int. Cl. G03D 3/00; G03D 13/08

(52) U.S. Cl. CPC G03D 3/00; G03D 13/08
USPC 396/580

(57) ABSTRACT

An improved light sensitive film and processing packet permits the production of rapidly processed, high quality negative films and a positive proof print using a simplified set of components. The reduced components afford more economical manufacture of a sheet type instant film article, with the further advantage that less residual waste material is produced. Integrated functions of negative, processing pod, and receiver sheet provide fast, simplified, yet highly detailed black and white and color photographs to be produced on conventional equipment.

### FIELD OF THE INVENTION

The present invention relates to photography and more particularly to instant photography using a very light sensitive film and associated processing packet. This application is based upon Provisional Patent Application No. 61/741,272, filed 16 Jul. 2013 and is incorporated herein by reference in its entirety.

### BACKGROUND OF THE INVENTION

Polaroid Corp manufactured and sold a sheet film system for producing instant single sheet photographs in both color and black and white. One such product was known as “Type 55” and consisted of a processing pod, a receiver sheet, various masking layers, rail spacers, a metal clip, a special perforated and cut roll film, and cover sheets. The product was popular but expensive, and produced a reasonable black and white photographic print and a high quality 4×5″ negative that could be torn from the perforated and cut roll film section, which was attached to a metal clip. Because of processing limitations, and the limitations of complex manufacturing with many stacked tolerances, the product could produce a properly exposed print, or a properly exposed negative, but not both. Use of the product involved pulling through rollers of a film back, and separating negative and positive after a certain duration, which produced several waste articles such as paper backing, paper front, a clip, and various peel-away mask layers.

### OBJECT OF THE INVENTION

It is the object of the invention to reduce the parts count of the packet, and reduce the residual waste articles, often referred to as “Polatrash”. It is another object of the invention to use a standard 4×5 film, rather than a specially made film, affording greater flexibility by the manufacturer and greatly reduced tooling costs, and less reliance on expensive, custom assembly machinery. In one aspect, the assembly of the packet can be carried out by hand operations with minimal tooling. It is another object of the invention to produce an instant positive and negative with both positive and negative properly exposed, rather than one or the other. It is another object of the invention to reduce or eliminate unneeded masks, perforations, and rails that add to cost and make manufacturing tooling complex and expensive to produce and maintain. In one aspect, a simple sleeve incorporating the receiver material as one unit is described. In another aspect, a carrier to hold ordinary sheet film is employed. In another aspect, a simple pod with a low toxicity chemical monobath is used to process the negative and positive portions that are aspects of the invention. In another aspect various films may interchangeability be used to produce different effects employing the Diffusion Transfer Reversal (DTR) process. In one embodiment, a positive negative system produces a metallic silver negative and a positive print comprising in part of the silver sols released during the development process. In another aspect, color films may be used. In one embodiment, a dye depletion negative releases colored dyes to a positive print, leaving a high quality color negative that may be scanned, contact printed, or enlarged. Various improvements to the art involve simplifying the manufacture and sourcing of components, reducing the cost, and balancing the performance so that greater value, improved manufacturability with reduced “Polatrash” are achieved. In accordance with the invention, high quality photography can be realized without excess reliance on special equipment, a darkroom, or special ability, other than the desire to produce and excellent, sharp, detailed photograph.

### BRIEF DESCRIPTION OF THE DRAWINGS

FIG. 1a is a plan view of the sleeve showing the front, or lens side.

FIG. 1b is a plan view of the sleeve showing the rear side.

FIG. 2 is a plan view of the insert showing the location of the pod, the negative, and the metal cap

FIG. 3 is a detail of the insert attached to the metal cap

FIG. 4 is a cross section view of the positive print side of the sleeve.

FIG. 5 is an example of a process flow chart of the assembly of the packet having a reduced number of steps relative to the prior art.

FIG. 6 is a block diagram of the series of physical actions that may occur to produce a balanced positive and negative photograph using the DTR process when used according to the invention.

FIG. 7 is a block diagram of a series of physical actions that may occur to produce a color photograph, and color negative when used according to the invention.

### DETAILED DESCRIPTION OF THE DRAWINGS

The descriptions and drawings used are illustrative of the concepts of the invention and may not be to scale, and are to be considered as examples from which certain variations may be accomplished without departing from the spirit and the scope of the invention. Generally, like numbers are used on various drawing sheets to indicate like components and features, but exceptions may occur.

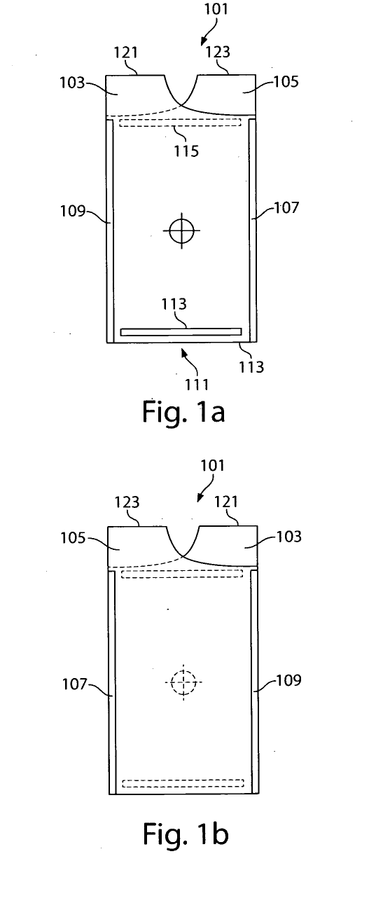

Referring now to FIG. 1a, the plan view of the sleeve showing the front, or lens side, it should be understood that the component called “sleeve” is a part of the packet consisting of sleeve and insert to form a complete packet, variously referred to as “product” or “film packet” in the disclosure. Sleeve 101 has a front or receiver side 103 and a back side made of paper 105 that are attached together at their sides by folded tape strips 107 and 109. Open end 111 is left open prior to final assembly of the product and may be trimmed after taping. Sleeve stop is securely glued onto the outside surface of receiver side 103 to provide a way for the sleeve 101 to be located during use. Hot glue strip 115 is sealed with an iron or other heat press once tape strips 107 and 109 are applied. Tape strips 107 and 109 may be made of black paper tape having an adhesive on one side that is effective to hold the sleeve together while providing some additional thickness along the edge. A typical thickness of the tape may be 0.003″ more or less, and doubled may provide 0.006″ or more thickness than just the front receiver side 103 and back side 105 if used alone.

The sleeve 101, when loaded with other articles that shall be described, will be passed through rollers at a later time, and the thickness of the tape 107 and 109 will afford good operation of the invention without the need for internally-placed spacers such as those found in prior art Polaroid products.

Remaining now on FIG. 1a, peel tabs 121 and 123 and cut into ear shapes that allow easy finger separation at a later time by pulling apart, breaking the hot glue strip 115, and then tearing along the creases provided by the bent edges of tape strips 107 and 109. Such tearing action may be aided by perforations, or by the sharp bend of the tape at the point of assembly, so it tears along the sharp bend, which is a weak point. The front, or lens side, which is also one with the receiver paper, is simple and requires no extra components such as prior art Polaroid products, and the outer surface may be marked with any inks, labels or decorations, and may be usefully marked with a “lens side” reminder in the form of a circle and cross hairs 125.

Referring now to FIG. 1b, a plan view of the sleeve 101 showing the rear side, it can be seen that tape 107 and 109 overlap the same amount as previously shown. A recommended overlap is about 0.187″ but may be more or less. Receiver side 103 has a special surface that is exposed in the view shown as FIG. 1b, and is continuous with the entire inside surface of receiver sheet 103. The special surface is an image receiving layer that will be further described, and it can be appreciated that making the special surface of one, continuous sheet of material in sleeve 101 reduces the number of needed components to one vs the many parts that were incorporated in prior art Polaroid materials. Because the receiver side is also the front side of the sleeve, the two functions are combined into one single piece of material.

The cost savings thus realized is significant, and reduces the amount of waste materials.

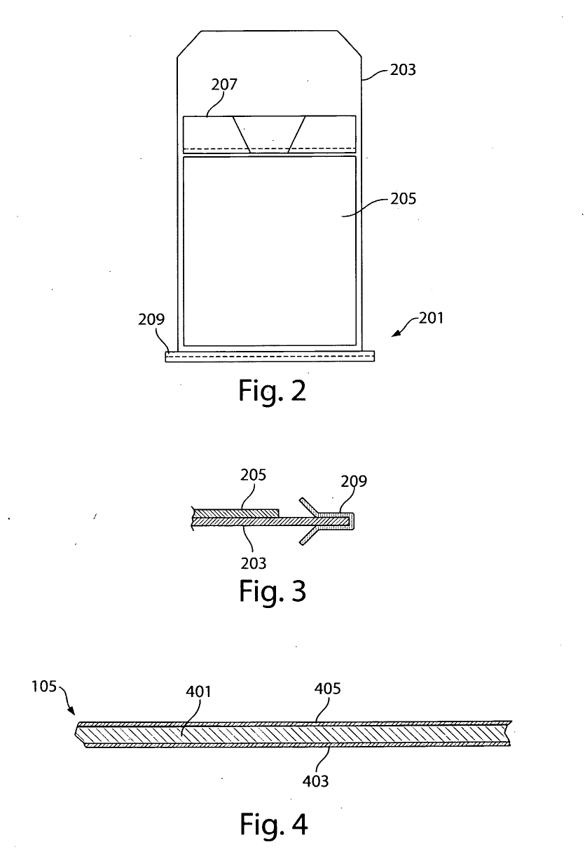

Referring now to FIG. 2, plan view of the insert showing the location of the pod, the negative, and the clip, insert 201 can be made of tongue 203 that is cut from a single sheet and sized to insert into sleeve 101 shown in FIGS. 1a and 1b. Returning now to FIG. 2, tongue 203 can be made of black paper to afford some additional light masking, and may be made of ordinary construction paper, or of a plastic material, as long as it is not too thick and has some axial stiffness to afford the ability to push into the sleeve without buckling. Upon tongue 203 may be glued, taped or otherwise attached negative 205. According to the invention, one such negative is a standard 4×5 inch sheet film having a plastic base such as polyethylene terapthalate or acetate, and at least one emulsion layer (not shown) consisting of gelatin and silver halide particles that are deposited according to the known photographic film art. Black and white and color films may be used. A suitable film may be EFKE brand 4″×5″ sheet film having an ISO speed of 25, 50 or 100. Other films may be used with the preference toward simple single layer emulsions that have rapid diffusion characteristics, as these process more quickly, produce a better result than more complex emulsions, and cost much less to produce.

Adjacent to negative 205 on FIG. 2 is shown monobath pod 207 oriented to allow pressure rollers to squeeze the contents like a ketchup package would between the assembled, exposed negative and receiver sheets. Construction of pod 207 consists of plastic coated heat sealable paper that is firmly heat sealed on three sides after folding, and on the fourth side with. a controlled burst adhesive that can be easily ruptured to allow the chemical monobath to spread in the direction of the negative 205. The contents of the pod 207 may consist of various monbaths that are known in the art with thickening agents and additional pH boosters that accelerate the reaction and transformation of the negative and positive elements of the packet during processing. A typical pH booster may be sodium hydroxide, though other high pH materials such as lithium hydroxide and potassium hydroxide may be used. The monobath has a developer, and a fixer in it, and a solvent to aid the lateral movement of the dissolved sols from the negative to the receiver via electrolytic action, much like an alkaline battery. Typical developers are hydroquinone, and typical fixers are sodium thiosulfate, while typical solvents are sodium sulfite. The production of sulfur compounds in a high pH layer is important to the production of aggregation of dissolved silver sols onto the receiver sheet to produce a positive image out of the parts of the negative that would ordinarily be washed away in tray processing. In particular, the electrolytic action on the receiver sheet is aided by the addition of nucleating metals that act as electrode sites to form 1 micron or greater islands of black or dark sulfur compounds that are electrolytically drawn out by ionic reaction from the negative, leaving the reduced silver metals behind in a selective fashion, and thus forming both a positive print, and a high quality negative. Pod 207 can be formed and filled by ordinary processing equipment such as that produced by Adaptive Manufacturing Technologies, 181 Remington Boulevard, Ronkonkoma, N.Y. 11779 and branded “Quick Pouch (198 )”.

Still referring to FIG. 2, tongue 203 is fitted with a metal cap 209 which allows the insert assembly 201 to be sealed in a light tight manner so that the packet can be handled in room light, yet have the insert assembly withdrawn when needed for the exposure of a photographic image. Such exposure is usually accomplished in a camera, (not shown) such as a 4×5 camera, fitted with a film back (also not shown). Suitable film backs are numerous and widely available and include Polaroid 545 type single sheet film backs.

Now referring to FIG. 3 the detail of the insert attached to the clip, one can appreciate the foldable action of the metal cap 209 squeezed onto the tongue 203 and placed adjacent to the negative 205 to form a slidable insert that seals light when inserted into the sleeve 101 of FIGS. 1a and 1b.

Referring now to FIG. 4, the cross section view of the positive print or receiver side of the sleeve, illustration of various desirable features is shown. Sheet 105 is comprised of a plurality of layers. Base layer 401 may be opaque duplex paper, or any opaque, reasonably stiff substrate, such as plastic. Backing coat 403 may be added to further aid opacification of the base layer 401 and provide lubricity, colors, and reduce curling which is common to coated materials. A back coat often can be used to counteract other coats on an opposite side and can be comprised of a paint, such as a latex paint which absorbs water from the air at about the same rate as other layers on the opposite surface. Nucleating layer 405 may be comprise of a deposition of the following: 1. a white layer, such as a baryta coating, 2. a base layer, such as polyacrylic acid, 3. a nucleating layer of finely dispersed metal nanoparticles, such as palladium particles produced in-situ by floating a palladium-containing salt, such as palladium chloride, then reducing the palladium chloride with a reducing agent such as sodium borohydride, or sodium hydroxide, to form nanoparticles on the spot that are not clumped owing to the physics of in-situ nucleation distribution, 4. a coating layer such as gelatin and 5. a release layer such as a fine spray or coating of gum arabic (acacia). Other layers may include metals such as silver, platinum, nickel and gold, with gold particles effective to produce various tones or colors that may be desired, and toning layers to produce colors or shades that are desired from the DTR. process. For color photography, the layer construction is different and can be as simple as a gelatin coated ink-jet type absorbant layer owing to the dye diffusion process, which is like printing. For black and white photography, a more complex receiver surface is required to produce a good quality black and white print with tonal characteristics.

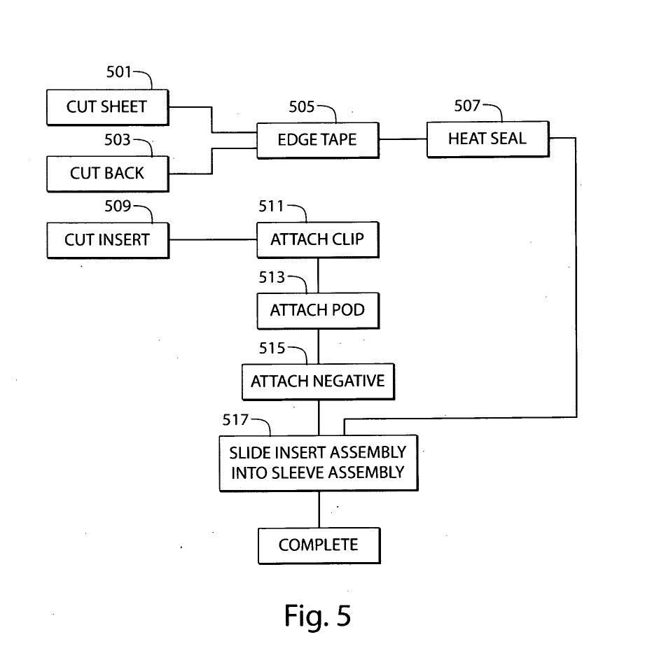

FIG. 5, example of a process flow chart of the assembly of the packet having a reduced number of steps relative to the prior art, address further the need for low cost and simplified manufacture of the product according to process steps as shown herein: Cut sheet 501 and cut back 503, taped along with edge tape step 505 and heat seal 507 are all that are needed to produce the sleeve 101 of FIGS. 1a and 1b. Returning to FIG. 5, a similarly short process is cut insert 509, attach clip or cap 511, attach pod 513, then attach negative 515. Doing these steps in this sequence allows hand building and experimentation and ready application to automation. The final step is to slide the insert assembly into the sleeve assembly process, 517, and the product is ready to be used. These sequences may be used for either color or black and white products, which is a great advantage, and may be adapted to other sizes such as 5×7, or 8×10 inches, or to smaller products by simply scaling up or down the dimensions. Dozens of prior art process steps are eliminated.

Unlike the assembly steps for both color and black and white which are the same, the physical processes that occur in the development of color vs black and white are different and should be appreciated.

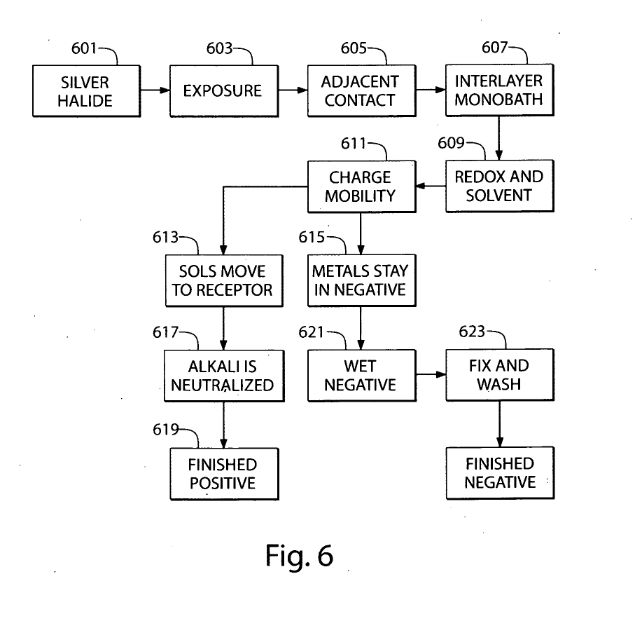

Referring now to FIG. 6, a block diagram of the series of physical actions that may occur to produce a balanced positive and negative black and white or monochrome photograph using the DTR process when used according to the invention, shown are the series of events as follows: Silver halide (on the film) 601 is exposed, 603 and placed into adjacent contact 605 with an interlayer monobath 607 that is comprised of a redox and solvent 609. The reaction of alkali and redox in the monobath 607 results in a charge mobility 611 of silver sols that migrate toward the receptor 613 at the same time that redox and solvent 609 reduce silver halides to the metallic state causing the metals to stay in the negative 615. With sols going one way and the metals going the other, a positive image is formed on one side, and a negative on the other. The alkali on the positive may be neutralized 617 to produce a finished positive print 619. The negative, which is still wet 621 may be further fixed and washed 613 and then dried to produce a finished negative.

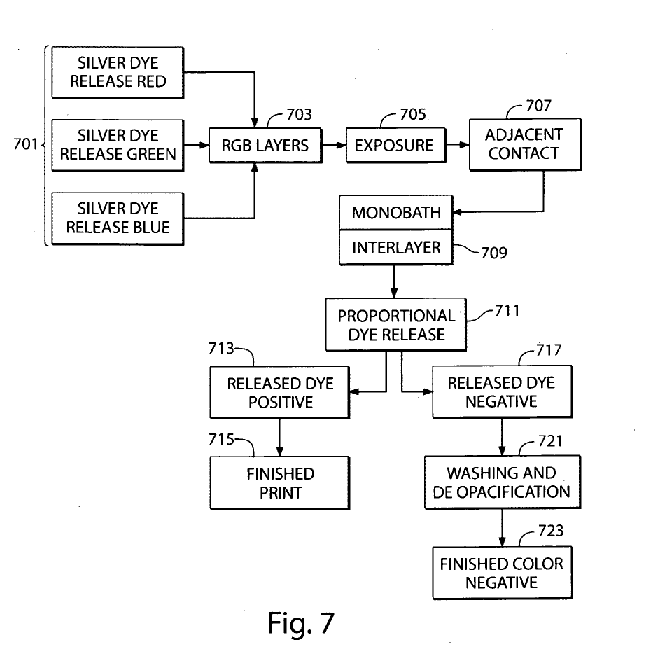

The process of color positive negative production is newer and even less appreciated in the art and is shown in FIG. 7, a block diagram of a series of physical actions that may occur to produce a color photograph, and color negative when used according to the invention. Three or more sensitized releasable dyes indicated as silver dye red, green and blue 701 are formed into RGB layers 703 upon the negative film. Exposure 705 of the RGB layers 703 is effective to allow adjacent contact 707 and a monobath interlayer to produce a proportional dye release 711 that is color and intensity selective. For instance, the more red exposed onto the negative, the greater release of red dye is afforded when placed in adjacent contact 707 and chemicals. Released dye positive 713 results from this proportionate release and may be carried out with each color of red, green and blue simultaneously to form the finished print 715, in color. Correspondingly, the depletion of dye in the negative to produce the finished print 715, leaves an opposite proportion of the selectively exposed spectral dyes, resulting in a, remaining dye negative 717 image, where darks are light, reds are generally green, greens are red, blues appear orange. Unlike conventional Kodak color negatives, the exact balance of these dyes is not critical nor is the presence of any masking layer, as common consumer scanners can correct and adjust well for reversal scanning. Washing and removal of an opaque layer and drying produces a finished color negative 721.

What has been shown is an improved system for photography that is fast, convenient and uses a reduced set of components and steps and utilizes novel juxtaposition of reduced sets of elements to accomplish high quality black and white and color photography.

1. An instant photography processing sleeve arrangement having a positive and a negative component, wherein when both positive and negative components to the sleeve arrangement are properly exposed reduce or eliminate unneeded masks, perforations, and rails that add to cost and make manufacturing tooling complex and expensive to produce and maintain, the positive component consisting of a stiff, opaque base layer having a backing coat to aid in opacification of the base layer, and a nucleating layer comprised of a deposition of a white barya coating layer, a polyacrylic acid base layer, a nucleating layer of finely dispersed palladium nanoparticles, a reducing agent such as sodium borohydride, a gelatin coating layer, and a release layer coating of gum arabic (acacia).

2. The sleeve arrangement as recited in claim 1, which incorporates a receiver material as one unit and a carrier to hold ordinary sheet film.

3. An instant photographic processing arrangement wherein a positive and negative system consists of both a metallic single silver negative and a single positive print by a development process which process comprises a positive component of silver sols is released during the development process and wherein a negative component releases colored dyes to a positive print.

4. An instant photography processing arrangement having a positive and a negative component, with both positive and negative components, including a sleeve which sleeve incorporates a receiver material as one unit and a carrier to hold ordinary sheet film, and wherein a positive and a negative system produces a single metallic silver negative and a single positive print comprising silver sols which are released during the development process and wherein a negative component releases colored dyes to a positive print, leaving a scannable, printable, enlargeable, negative.
